(19) United States
(12) Patent Application Publication
(10) Pub. No.: US 2023/0067407 A1
(43) Pub. Date: Mar. 2, 2023

(54) COOLING DEVICE FOR COOLING POWER ELECTRONICS OF A BATTERY SYSTEM, AND BATTERY SYSTEM

(71) Applicant: Robert Bosch GmbH, Stuttgart (DE)

(72) Inventor: Markus Schmitt, Tamm (DE)

(21) Appl. No.: 17/893,278

(22) Filed: Aug. 23, 2022

(30) Foreign Application Priority Data
Aug. 25, 2021 (DE) 10 2021 209 308.6

(51) Int. Cl. H01M 10/6568; H01M 10/613; H01M 50/204; H01M 10/625; H01M 10/42

(52) U.S. Cl. CPC H01M 10/6568; H01M 10/613; H01M 50/204; H01M 10/625; H01M 10/425; H01M 2220/20

(57) ABSTRACT

A cooling device for cooling power electronics of a battery system comprising a plurality of battery cells, the cooling device having a cooling channel with a cooling channel base, with a cooling channel top, and with at least one cooling channel wall, wherein the power electronics are connectable in a heat-transferring manner to the cooling channel top on a side of the cooling channel top facing away from the cooling channel, wherein the cooling device has an inlet port for inflow of a cooling liquid into the cooling channel and an outlet port for outflow of the cooling liquid from the cooling channel, wherein the cooling channel top has a base surface and at least one elevation on the side facing the cooling channel, wherein the elevation forms a venting space, and wherein the cooling device has a venting interface for venting the venting space.

### BACKGROUND OF THE INVENTION

The present invention relates to a cooling device for cooling power electronics of a battery system, in particular for a motor vehicle. Furthermore, the invention relates to a battery system comprising a battery cell stack with a plurality of battery cells, power electronics, and a cooling device.

In the known prior art, individual battery cells are interconnected to form battery modules. Battery modules are interconnected to form batteries or battery systems. Due to the large number of different vehicle installation spaces, variable module sizes are required in order to make optimum utilization of the available installation space. Li-ion or Li-polymer battery cells heat up as a result of chemical conversion processes, especially during rapid energy delivery or absorption. The more powerful the battery pack, the greater its heating and the associated efficient active thermal management system. This allows the battery cells and/or power electronics of the battery system to be cooled and heated. Here, the battery cells have to be cooled predominantly.

The optimum operating temperature of Li-ion battery systems is approximately +5° C. to +35° C. Above an operating temperature of approximately +40° C., their service life is reduced. To achieve the service life requirement of approximately 8-10 years, sufficient thermal conditioning of the battery is therefore required. The battery cells and/or the power electronics of the battery system must be kept in a thermally uncritical state under all operating conditions. To achieve an aging synchronization of the battery cells, the temperature gradient from battery cell to battery cell and/or within the power electronics of the battery system must be only slight.

Today, battery system heating and cooling is mainly carried out by means of liquid temperature control with a water/glycol mixture. This is fed through channels in the cooling plates located underneath the battery modules and/or the power electronics of the battery system. The cooling plates are supplied by means of a cooling water supply system with corresponding additional components in the cooling circuit.

A disadvantage of the known cooling circuits for cooling power electronics of a battery system is that they do not provide an advantageous solution for venting.

### SUMMARY OF THE INVENTION

The invention provides a cooling device for cooling power electronics of a battery system. Furthermore, the invention provides a battery system comprising a battery cell stack with a plurality of battery cells, power electronics, and a cooling device mentioned above. Further advantages and details of the invention are provided by the dependent claims, the description and the drawings. Features described in conjunction with the cooling device according to the invention of course also apply in conjunction with the battery system according to the invention and vice versa in each case, and therefore reference is or can always be made mutually with regard to the disclosure concerning the individual aspects of the invention.

According to a first aspect, the invention provides a cooling device for cooling power electronics of a battery cell stack comprising a plurality of battery cells. The cooling device has a cooling channel with a cooling channel base, with a cooling channel top, and with at least one cooling channel wall, wherein the power electronics are connectable in a heat-transferring manner to the cooling channel top on a side of the cooling channel top facing away from the cooling channel. The cooling device has an inlet port for inflow of a cooling liquid into the cooling channel and an outlet port for outflow of the cooling liquid from the cooling channel. The cooling device is characterized in that the cooling channel top has a base surface and at least one elevation on the side facing the cooling channel, wherein the elevation forms a venting space, and wherein the cooling device has a venting interface for venting the venting space.

In the context of the invention, a coordinate system defines the positional and directional indications in such a way that a cooling channel top represents the upper boundary of the cooling channel according to the invention. Consequently, the cooling channel base represents the lower boundary of the cooling channel according to the invention and the at least one cooling channel wall represents the lateral and/or vertical boundaries of the cooling channel according to the invention. The power electronics are thus preferably arranged above the cooling channel top in an installed state. The battery cell stack is preferably arranged below an assembly of power electronics and cooling device. Of course, this arrangement can also be installed rotated about at least one spatial axis, so that the positional and directional indications are to be understood as relative indications of the claimed features.

The cooling channel top is preferably planar or substantially planar. The cooling channel top comprises a side facing the cooling channel and an opposite side facing away from the cooling channel. The power electronics can be connected to the cooling channel top in a heat-transferring manner on the side facing away from the cooling channel. As described in greater detail later, the power electronics comprise at least one logic device and at least one power device. Preferably, the power electronics is designed as a circuit board. By way of example, the power electronics are divided into two portions: a portion for the logic device and a portion for the power device. The logic device and the power device are preferably to be understood as assemblies of a plurality of components with which the power electronics are populated. Particularly for reasons of installation space, the power electronics in the region of the portion of the logic device are populated on both sides, whereas the power device is only populated on one side. The logic device has a lower cooling requirement due to lower heat production. The heat-transferring connection between the power electronics and the cooling device is preferably enabled in the portion of the power device, in particular on the non-populated underside of the power electronics in the portion of the power device. In order to enable the smallest possible installation space, low wall thicknesses, and advantageous heat-transferring contacting between the cooling device, in particular the cooling channel top, and the power electronics, the cooling channel top has a base surface and at least one elevation. According to the invention, the elevation is to be understood as an elevation of the cooling channel top upwards, in the direction of the power electronics. Preferably, the cooling channel top has the same or substantially the same material thickness, so that the elevation of the cooling channel top forms a depression on the side of the cooling channel top facing away from the cooling channel in the region of the base surface. The phrase “X or substantially X” is intended to be understood in the context of the invention as a possible, minor deviation, for example due to manufacturing tolerances, material and/or process properties, without changing the underlying, intended function of the feature. By way of demonstration, the cooling channel top thus has at least one elevation on the underside and, resulting therefrom, at least one depression on the upper side. The indentation of the upper side preferably serves for the advantageous utilization of the installation space for the power electronics, in particular the previously described double-sided population of the power electronics in the portion of the logic device. The venting space is consequently formed by the elevation and/or represents, by way of demonstration, the volume difference to a cooling channel top which is hypothetically flat instead of having the elevation.

The difference in height between the base surface and the elevation in the cooling channel, in particular through the venting space, results in the need for a venting means, since an unvented cooling channel, in particular an air bubble within the cooling channel, adversely affects the cooling performance of the cooling device. In particular, when the cooling device is filled with cooling liquid for the first time, it is preferable to fill it with negative pressure so that virtually no air remains in the cooling device. An air cushion in the cooling channel leads to the fact that the electronic components on the circuit board of the power electronics in the region of the air cushion can no longer be sufficiently cooled and/or are permanently damaged. Since the difference in height between the base surface and the elevation can be relatively large, there is usually no venting even when the coolant circuit is in operation. An air cushion remains permanently in the cooling device. A cooling device according to the invention with a venting interface allows complete or substantially complete venting, in particular in the course of a refilling during operation of the battery system and/or motor vehicle, and also a filling without negative pressure. The venting interface according to the invention is preferably to be understood as an opening, in particular an openable and closable opening, of the cooling channel, in particular in and/or through the cooling channel wall. The venting interface is preferably arranged so as to allow complete or substantially complete venting of the cooling device, in particular of the venting space.

Preferably, the cooling channel top has a plurality of, in particular parallel, heat transfer surfaces on a side facing away from the cooling channel, in order to allow the most advantageous heat transfer possible from the power electronics.

A cooling device designed in this way is particularly advantageous, since cooling of the power electronics is provided, wherein a venting of the cooling channel, in particular of the venting space, is made possible by particularly simple and cost-effective means.

According to a preferred further development of the invention, it can be provided in a cooling device that the cooling channel top has two planes, wherein the second plane is arranged above the first plane, wherein the base surface is arranged in the first plane, and wherein the venting space extends between the first plane and the second plane, in particular wherein the first plane and the second plane are formed parallel to one another. Preferably, the venting interface is thus arranged between the first plane and the second plane. Preferably, the extent of the cooling channel top is at least in portions in and/or along the planes, wherein the base surface preferably extends in and/or along the first plane and the elevation preferably extends in and/or along the second plane. Thus, a venting space is preferably formed between the first and second planes or substantially between the first and second planes. In the context of the invention, the planes are preferably to be understood as theoretical planes in and/or along which the cooling channel top extends.

According to a preferred further development of the invention, it can be provided in a cooling device that the venting space, in particular an upper side of the venting space, rises along a flow path of the cooling liquid at least in portions, in particular up to the venting interface. A rising of the venting space, in particular of the upper side of the venting space, is to be understood in the context of the invention in such a way that, in an installed state of the cooling device, the venting space, in particular the upper side of the venting space, is designed to be inclined in an ascending manner at least in portions and thus increases in height with respect to a vertical space axis. A cooling device formed in this way is particularly advantageous, since an air bubble within the cooling channel thus moves along the upper side of the venting space to a highest point, in particular up to the venting interface, and the cooling device can be advantageously vented.

According to a preferred further development of the invention, it can be provided in a cooling device that the venting space has an initial portion and an end portion along the flow path of the cooling liquid, wherein the venting interface is arranged in the end portion of the venting space. Trapped air in the cooling channel mostly collects and/or moves along the flow path of the coolant. Thus, in order to be able to completely or substantially completely vent the cooling channel, the arrangement of the venting interface in the end portion of the venting space is particularly advantageous.

According to a preferred further development of the invention, it can be provided in a cooling device that the venting interface has a smaller diameter for venting than a diameter of the inlet port for the cooling liquid and/or a diameter of the outlet port for the cooling liquid and/or that the inlet port and/or the outlet port are arranged below the base surface. In most cases, only small amounts of air are vented from the cooling device. A venting interface with a smaller diameter for venting advantageously allows venting and facilitates prevention of larger amounts of cooling liquid escaping during the venting. An arrangement of the inlet port and/or the outlet port below the base surface is advantageous in terms of installation space.

According to a preferred further development of the invention, it can be provided in a cooling device that the flow channel comprises a plurality of flow disturbance devices, in particular wherein the flow disturbance devices are connected to the cooling channel top and extend towards the cooling channel base. The plurality of flow disturbance devices enable an increase in the cooling performance by, for example, swirling of the flow of the cooling liquid within the cooling channel and/or by increasing the surface area for heat transfer between the cooling device and the cooling liquid. The plurality of flow disturbance devices may be in the form of pins, columns, cylinders, cones and/or other flow disturbance devices. The flow disturbance devices are preferably formed in an integrally bonded manner, in particular in one piece, with the cooling channel top.

According to a preferred further development of the invention, it can be provided in a cooling device that the venting space is arranged in a U-shape around the base surface, at least in portions. Preferably, the power electronics are designed in such a way that the logic device is arranged in the form of components in a central portion on one side of the power electronics, which are designed, for example, as a circuit board. The power device is preferably arranged in a U-shape on the power electronics and around the logic device. Designed in this way, the power electronics enable an advantageously long U-shaped cooling channel along the power device, so that a large area is available for transferring the heat of the power device to the cooling device. A cooling device designed in this way enables particularly advantageous cooling and, at the same time, high installation space efficiency and small distances between the components of the logic device and the power device.

In accordance with a preferred further development of the invention, it can be provided in a cooling device that the cooling device has a main body, in particular a housing, wherein the cooling channel is designed in an integrally bonded manner in the main body, and/or wherein the main body is designed to receive the power electronics and/or the battery cell stack. A main body according to the invention, in particular a housing, advantageously allows positional securing, arrangement, sealing and/or protection against dirt and other environmental influences for the cooling device, the power electronics and/or the battery cell stack. The main body is preferably designed as a die-cast housing and/or advantageously comprises fastening devices for fastening in a motor vehicle.

According to a second aspect, the invention provides a battery system comprising a battery cell stack having a plurality of battery cells, power electronics, and a cooling device. The power electronics are connected in a heat-transferring manner to the cooling channel top on the side of the cooling channel top facing away from the cooling channel. The cooling device is designed in accordance with the first aspect. In the battery system described, all the advantages already described with respect to the cooling device according to the first aspect of the invention are provided. A battery system according to the invention is particularly advantageous because cooling of the power electronics and venting of the cooling device are made possible by particularly simple and cost-effective means.

According to a preferred further development of the invention, it can be provided in a battery system that the power electronics comprise a logic device and a power device, in particular wherein the logic device is arranged on the side of the base surface of the cooling channel top facing away from the cooling channel, and wherein the power device is arranged on the side of the venting space of the cooling channel top facing away from the cooling channel. A battery system designed in this way allows cooling of the power electronics and venting of the cooling device in a particularly advantageous and space-saving manner. The power electronics are preferably designed, as described above, as a circuit board with a logic portion and a power portion, wherein the logic portion is preferably populated with components on both sides of the circuit board. The heat-conducting connection of the power electronics to the cooling device is preferably enabled in the power portion, since this has the greatest cooling requirement.

### BRIEF DESCRIPTION OF THE DRAWINGS

A cooling device according to the invention and a battery system will be explained in more detail below with reference to drawings, which show schematically, in each case:

FIG. 1 a sectional side view of a battery system comprising a battery cell stack with a plurality of battery cells, power electronics and a cooling device,

FIG. 2 a perspective view from below of a cooling device, and

FIG. 3 a sectional perspective view from the side of another cooling device.

### DETAILED DESCRIPTION

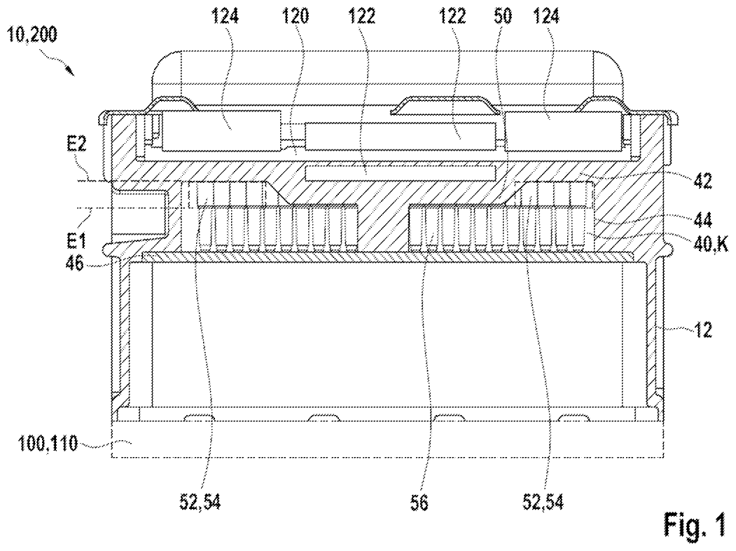

Elements with the same function and mode of operation are each provided with the same reference signs in FIGS. 1 to 3.

FIG. 1 shows a schematic sectional side view of a battery system 200 with a battery cell stack 100 with a plurality of battery cells 110, power electronics 120, and a cooling device 10. The cooling device 10 for cooling the power electronics 120 of the battery cell stack 100 with a plurality of battery cells 110 has a cooling channel 40 with a cooling channel base 46, with a cooling channel top 42, and with at least one cooling channel wall 44. The power electronics 120 are connected in a heat-transferring manner to the cooling channel top 42 on a side of the cooling channel top 42 facing away from the cooling channel 40. On the side facing the cooling channel 40, the cooling channel top 42 has a base surface 50 and at least one elevation 52, wherein the elevation 52 forms a venting space 54. The cooling channel top 42 has two planes E1, E2, wherein the second plane E2 is arranged above the first plane E1, wherein the base surface 50 is arranged in the first plane E1, and wherein the venting space 54 extends between the first plane E1 and the second plane E2, wherein the first plane E1 and the second plane E2 are formed parallel to one another. The flow channel 40 comprises a plurality of flow disturbance devices 56, wherein the flow disturbance devices 56 are connected to the cooling channel top 42 and extend towards the cooling channel base 46. The cooling device 10 has a main body 12 in the form of a housing, wherein the cooling channel 40 is formed in an integrally bonded manner in the main body 12, and wherein the main body 12 is designed to receive the power electronics 120 and the battery cell stack 100. The power electronics 120 comprises a logic device 122 and a power device 124, wherein the logic device 122 is arranged on the side of the base surface 50 of the cooling channel top 42 facing away from the cooling channel 40, and wherein the power device 124 is arranged on the side of the venting space 54 of the cooling channel top 42 facing away from the cooling channel 40

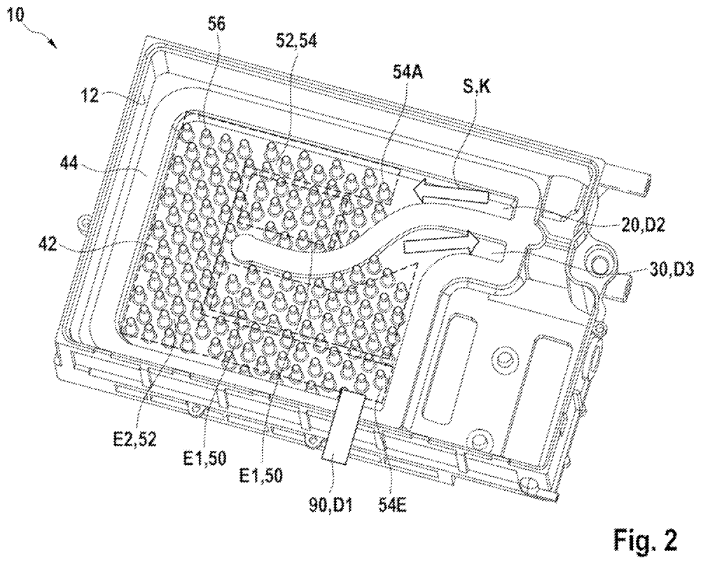

FIG. 2 shows a schematic perspective view from below of cooling device 10. The cooling device 10 has an inlet port 20 for inflow of a cooling liquid K into the cooling channel 40, an outlet port 30 for outflow of the cooling liquid K from the cooling channel 40. The cooling device 10 has a venting interface 90 for venting the venting space 54. The venting space 54 has an initial portion 54A and an end portion 54E along the flow path S of the cooling liquid K, wherein the venting interface 90 is arranged in the end portion 54E of the venting space 54. The venting interface 90 has a smaller diameter D1 for venting than a diameter D2 of the inlet port 20 for the cooling liquid K and a diameter D3 of the outlet port 30 for the cooling liquid K. The inlet port 20 and the outlet port 30 are arranged below the base surface 50, in this case in front of the base surface 50 out of the image plane. The venting space 54 is arranged in a U-shape around the base surface 50, at least in portions.

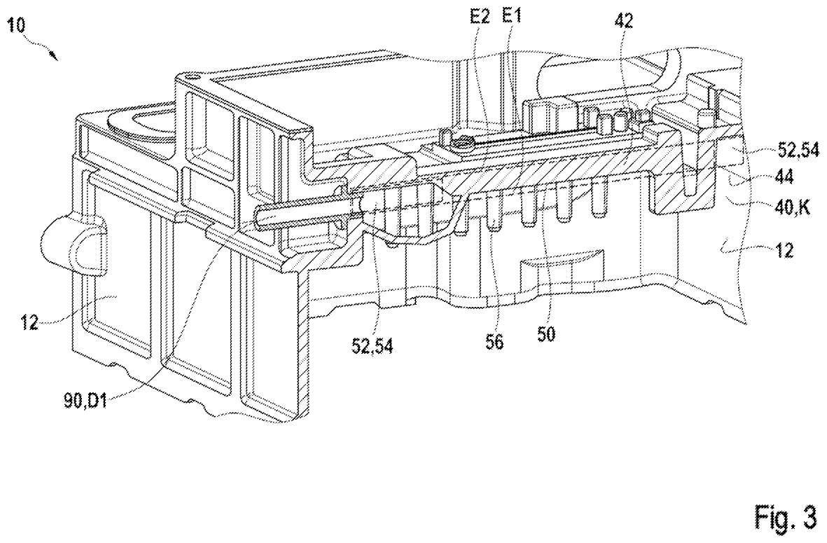

FIG. 3 shows a schematic sectional perspective view of another cooling device 10 from the side. FIG. 3 advantageously shows how the venting interface 90 is configured for venting the venting space 54 and is arranged for this purpose between the first plane E1 and the second plane E2. A cooling device 10 configured in this way is particularly advantageous, since cooling of the power electronics 120 (not shown) is provided, wherein venting of the cooling channel 40, in particular of the venting space 54, is made possible by particularly simple and cost-effective means.

1. A cooling device (10) for cooling power electronics (120) of a battery system (200) comprising a plurality of battery cells (110), the cooling device (10) having a cooling channel (40) with a cooling channel base (46), with a cooling channel top (42), and with at least one cooling channel wall (44), wherein the power electronics (120) are connectable in a heat-transferring manner to the cooling channel top (42) on a side of the cooling channel top (42) facing away from the cooling channel (40), wherein the cooling device (10) has an inlet port (20) for inflow of a cooling liquid (K) into the cooling channel (40) and an outlet port (30) for outflow of the cooling liquid (K) from the cooling channel (40),
wherein the cooling channel top (42) has a base surface (50) and at least one elevation (52) on a side facing the cooling channel (40), wherein the elevation (52) forms a venting space (54), and wherein the cooling device (10) has a venting interface (90) for venting the venting space (54).

2. The cooling device (10) according to claim 1,
wherein the cooling channel top (42) has first and second planes (E1, E2), wherein the second plane (E2) is arranged above the first plane (E1), wherein the base surface (50) is arranged in the first plane (E1), and wherein the venting space (54) extends between the first plane (E1) and the second plane (E2).

3. The cooling device (10) according to claim 1,
wherein the venting space (54) rises along a flow path (S) of the cooling liquid (K) at least in portions.

4. The cooling device (10) according to claim 3,
wherein the venting space (54) has an initial portion (54A) and an end portion (54E) along the flow path (S) of the cooling liquid (K), wherein the venting interface (90) is arranged in the end portion (54E) of the venting space (54).

5. The cooling device (10) according to claim 1,
wherein the venting interface (90) has a smaller diameter (D1) for venting than a diameter (D2) of the inlet port (20) for the cooling liquid (K) and/or a diameter (D3) of the outlet port (30) for the cooling liquid (K), and/or
the inlet port (20) and/or the outlet port (30) are arranged below the base surface (50).

6. The cooling device (10) according to claim 1,
wherein the flow channel (40) comprises a plurality of flow disturbance devices (56).

7. The cooling device (10) according to claim 1,
wherein the venting space (54) is arranged in a U-shape around the base surface (50), at least in portions.

8. The cooling device (10) according to claim 1,
wherein the cooling device (10) has a main body (12), wherein the cooling channel (40) is configured in an integrally bonded manner in the main body (12), and/or wherein the main body (12) is configured to receive the power electronics (120) and/or the battery cell stack (100).

9. The cooling device (10) according to claim 1,
wherein the cooling channel top (42) has first and second planes (E1, E2), wherein the second plane (E2) is arranged above the first plane (E1), wherein the base surface (50) is arranged in the first plane (E1), wherein the venting space (54) extends between the first plane (E1) and the second plane (E2), and wherein the first plane (E1) and the second plane (E2) are formed parallel to one another.

10. The cooling device (10) according to claim 1,
wherein an upper side of the venting space (54) rises along a flow path (S) of the cooling liquid (K) at least in portions, up to the venting interface (90).

11. The cooling device (10) according to claim 10,
wherein the venting space (54) has an initial portion (54A) and an end portion (54E) along the flow path (S) of the cooling liquid (K), wherein the venting interface (90) is arranged in the end portion (54E) of the venting space (54).

12. The cooling device (10) according to claim 1,
wherein the flow channel (40) comprises a plurality of flow disturbance devices (56), and wherein the flow disturbance devices (56) are connected to the cooling channel top (42) and extend towards the cooling channel base (46).

13. The cooling device (10) according to claim 1,
wherein the cooling device (10) has a housing (12), wherein the cooling channel (40) is configured in an integrally bonded manner in the housing (12), and/or wherein the housing (12) is configured to receive the power electronics (120) and/or the battery cell stack (100).

14. A battery system (200) comprising a battery cell stack (100) having a plurality of battery cells (110), power electronics (120), and a cooling device (10) according to claim 1,
wherein the power electronics (120) are connected in a heat-transferring manner to the cooling channel top (42) on the side of the cooling channel top (42) facing away from the cooling channel (40).

15. The battery system (200) according to claim 14,
wherein the power electronics (120) comprise a logic device (122) and a power device (124).

16. The battery system (200) according to claim 14,
wherein the power electronics (120) comprise a logic device (122) and a power device (124), wherein the logic device (122) is arranged on the side of the base surface (50) of the cooling channel top (42) facing away from the cooling channel (40), and wherein the power device (124) is arranged on the side of the venting space (54) of the cooling channel top (42) facing away from the cooling channel (40).
